(19) United States
(12) Patent Application Publication
(10) Pub. No.: US 2013/0078029 A1
(43) Pub. Date: Mar. 28, 2013

(54) COUPLING DEVICE

(71) Applicant: Jason A. Evans, Waterloo, IA (US)

(72) Inventor: Jason A. Evans, Waterloo, IA (US)

(21) Appl. No.: 13/242,058

(22) Filed: Sep. 23, 2011

(51) Int. Cl. F16B 7/18; F16B 7/00

(52) U.S. Cl. 403/187

(57) ABSTRACT

A coupling device comprises a mounting tube having a shank defining at least one hole therethrough, the shank sized to be received within a receiving tube; a flange attached to the mounting tube; a collar disposed on the mounting tube between the receiving tube and the flange; a strike plate attached to the collar and disposed proximate to the flange, and the flange or strike plate defining a through-hole. A bolt is disposed within the through-hole and in contact with the strike plate or flange. A mounting post or plate may be attached to the mounting tube, and a reinforcing member may be attached to the mounting tube and the mounting post. The mounting tube may define a hole in an end portion, which may be sized to receive a shank from another tube.

### BACKGROUND

The field of the invention is coupling devices, and in some embodiments, coupling devices that can be used in connection with trailer hitch receivers.

Vehicle trailer hitches have long been employed for towing trailers behind vehicles. Modern hitches are commonly of a basic modular design, having two principal components: a receiver tube attached to a vehicle, typically the frame of a vehicle, and a drawbar or hitch bar that is inserted into the receiver tube and secured to the receiver tube with a hitch pin or loading pin through aligned holes in the receiver tube and drawbar. For most conventional towing, the drawbar includes a hitch ball platform into which can be inserted a hitch ball or trailer ball that mates with a coupler found on the tongue of a trailer.

This modular design of trailer hitches is advantageous, as it allows the mounting of accessories other than trailers to a hitch receiver. Common accessories mounted in this way include bicycle racks and cargo platforms. One shortcoming of most current designs, however, is that the shank of an accessory seldom fits snugly in a hitch receiver tube, consequently, the accessory is not mounted securely. While the existence of play or slop in such a mount may be inconsequential for some accessories, it would be beneficial to be able to mount many accessories securely to a vehicle through a hitch receiver such that there is no play in the coupling between the accessory and the hitch receiver. The present coupling device is such a mount.

### SUMMARY

One embodiment of the present coupling device comprises a mounting tube having a shank defining at least one hole therethrough, the shank sized to be received within a receiving tube; a flange attached to the mounting tube; a collar disposed on the mounting tube between the receiving tube and the flange; a strike plate attached to the collar and disposed proximate to the flange, and the flange or the strike plate defining a through-hole. A bolt is disposed within the through-hole and in contact with either the strike plate or the flange, and the through-hole may be threaded. A mounting post or plate may be attached to the mounting tube, the post may be substantially normal to the mounting tube, and a reinforcing member may be attached to the mounting tube and the mounting post. The mounting tube may define a hole in an end portion distal to the shank, and the end portion of the mounting tube may be sized to receive a shank from an additional tube.

Another embodiment of the present coupling device comprises a substantially rigid, elongate tube having a major axis and a shank defining a proximate end of the tube wherein the shank is sized to be received within a receiving tube; the shank further defining at least one hole therethrough; a substantially planar flange attached to the elongate tube wherein the flange is substantially normal to the major axis of the elongate tube; a collar slidably disposed on the elongate tube between the receiving tube and the flange; a substantially planar strike plate attached to the collar wherein the strike plate is substantially normal to the major axis of the elongate tube and disposed proximate to the flange; and the flange or the strike plate defining at least one through-hole. A bolt is disposed within the at least one through-hole and in contact with either the strike plate or the flange, and the through-hole may be threaded. A mounting post or plate may be attached to the elongate tube, the post may be substantially normal to the elongate tube, and a reinforcing member may be attached to the elongate tube and the mounting post. The elongate tube may define a hole in an end portion distal to the shank, and the end portion of the elongate tube may be sized to receive a shank from an additional tube.

Another embodiment of the present coupling device for securely attaching objects to a trailer hitch receiver, comprises a substantially rigid, elongate tube having a major axis and a shank defining a proximate end of the tube wherein the shank is sized to be received within the receiver; the shank further defining at least one hole therethrough; a substantially planar flange attached to the elongate tube wherein the flange is substantially normal to the major axis of the elongate tube; a collar slidably disposed on the elongate tube between the receiving tube and the flange; a substantially planar strike plate attached to the collar wherein the strike plate is substantially normal to the major axis of the elongate tube and disposed proximate to the flange; the flange or the strike plate defining at least one threaded through-hole; a bolt disposed within the at least one threaded through-hole and in contact with either the strike plate or the flange; a mounting post attached to the elongate tube substantially normal to the major axis of the tube; and a mounting plate attached to the mounting post. A reinforcing member may be attached to the elongate tube and the mounting post.

### DESCRIPTION OF THE DRAWINGS

FIG. 1 is a perspective view of an embodiment of a coupling device.

FIG. 2 is a perspective view of a portion of an embodiment of a coupling device.

FIG. 3 is a perspective view of a portion of an embodiment of a coupling device.

### DETAILED DESCRIPTION

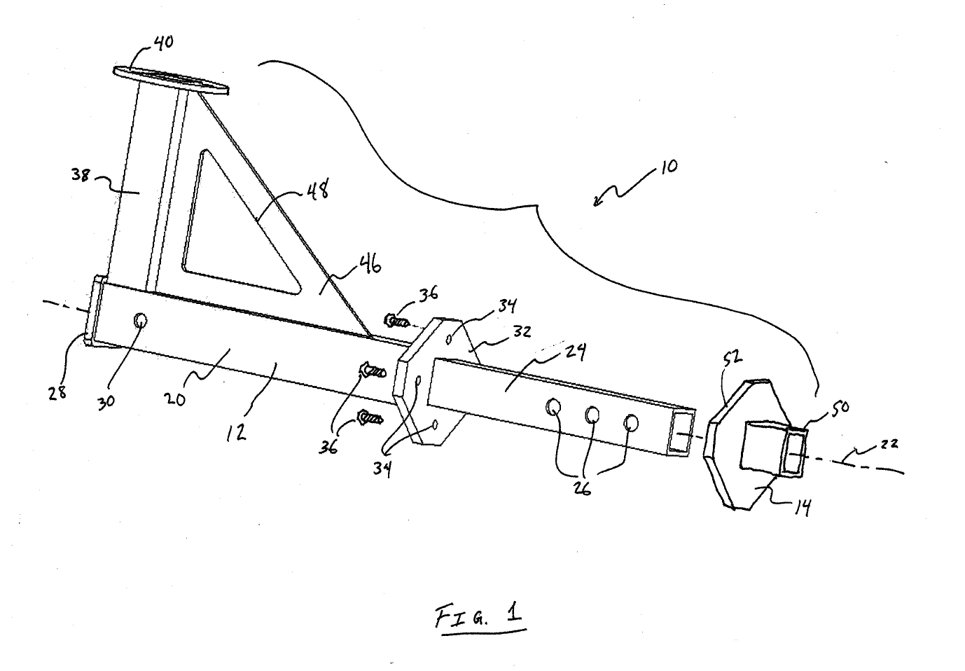

FIG. 1 shows an embodiment of the coupling device 10 comprising two principal components, namely, a mounting tube portion 12 and a collar 14. The mounting tube portion 12 comprises an elongated mounting tube 20 having a major axis 22. In the embodiment shown in FIG. 1, the mounting tube 20 is substantially square in cross-section, and is substantially hollow, although neither of these characteristics are critical to the operation of the coupling device 10. One end of the mounting tube 20 comprises a shank 24. The shank 24 is sized to fit inside a conventional trailer hitch receiver tube (not shown) or other similarly sized tube (not shown). The shank 24 defines one or more holes 26 through the lateral sides of the mounting tube 20 which can align with holes found in a conventional trailer hitch receiver tube (not shown) or other similarly sized tube (not shown) for receiving a hitch pin (not shown). Distal from the shank 24 on the mounting tube 20 is end portion 28. End portion 28 is sized to receive a shank (not shown) from another drawbar, hitch bar, mounting tube, or the like (not shown), and the end portion 28 defines one or more holes 30 through the lateral sides of the mounting tube 20 which can align with holes found in the shank of another drawbar, hitch bar, mounting tube, or the like (not shown) for receiving a hitch pin (not shown).

A substantially planar flange 32 is attached to the mounting tube 20. The flange 32 is oriented substantially normal to the major axis 22 of the mounting tube 20. In the embodiment shown in FIG. 1, the flange 32 defines one or more holes 34 each sized to receive a bolt 36 therethrough. In some embodiments, the holes 34 may be threaded to cooperate with threads on the bolts 36.

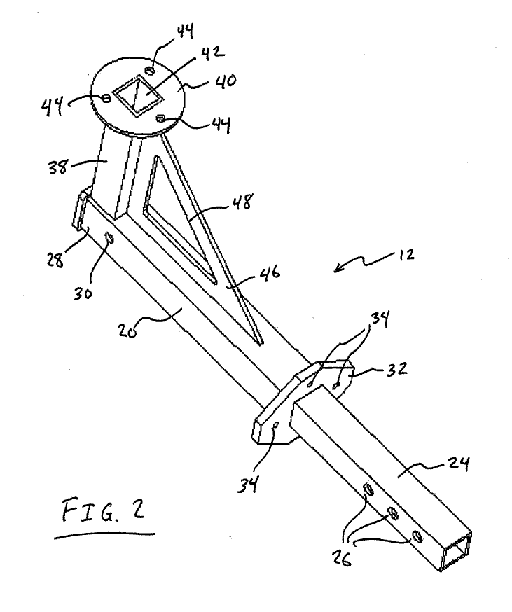

In the embodiment shown in FIG. 1, the mounting tube 20 also has a mounting post 38 attached to the end portion 28 of the mounting tube 20. In this embodiment, the mounting post 38 is substantially normal to the major axis 22 of the mounting tube 20. A mounting plate 40 is attached to the end of the mounting post 38. As seen more clearly in FIG. 2, the mounting plate 40 is substantially circular, and in this embodiment defines a central opening 42 open to the interior of the mounting post 38. The mounting plate 40 also defines one or more holes 44. In the embodiment shown in FIGS. 1 and 2, a reinforcing member 46 reinforces the attachment of the mounting post 38 to the mounting tube 20. The reinforcing member 46 in this embodiment defines a hole 48 in order to reduce the overall weight of the mounting tube portion 12 of the coupling device 10.

The embodiment shown in FIG. 1 is a substantially “universal” coupling device to which a variety of accessories may be mounted on the mounting plate 40. In alternative embodiments (not shown), the mounting post 38 may be omitted and the mounting plate 40 may be attached directly to the mounting tube 20. Moreover, neither the mounting post 38 or mounting plate 40 is limited to the sizes and shapes shown in FIGS. 1 and 2. Either component can be modified to accommodate the mounting of nearly any accessory or to develop other universal or dedicated mounting systems. Further, some embodiments of the coupling device 10 may include multiple mounting posts 38 and/or mounting plates 40 to accommodate the mounting of multiple accessories. There is no theoretical limitation or requirements for the construction and orientation of mounting posts 38 and mounting plates 40 in connection with the coupling device 10.

Further, the coupling device 10 may be used as a dedicated mount integrated with a dedicated accessory such as a bike rack, cargo platform, or the like. In such an embodiment, one or more components of the coupling device 10 from the embodiment shown in FIG. 1 may be omitted, including the mounting post 38, mounting plate 38, reinforcing member 46, and open end portion 28 and associated holes 30. Of course, these components may also be included even in a dedicated coupling device integrated with a dedicated accessory, and some components may be included while others are omitted. Again, there is no theoretical limitation or requirements for use of these components in connection with the coupling device 10 in a dedicated embodiment.

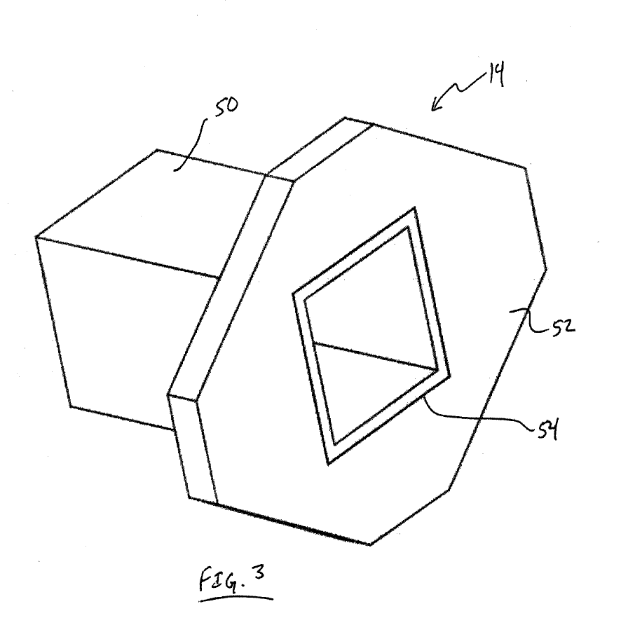

Returning to FIG. 1, the second principal component of the coupling device 10 is the collar 14. The collar 14 is also shown in detail in FIG. 3. The collar 14 comprises a tube 50 and strike plate 52. The strike plate 52 defines a central opening 54 open to the interior of the tube 50. The tube 50 and central opening 54 are sized to slide over the shank 24 of the mounting tube 20 such that the strike plate 52 abuts or is in close proximity to the flange 32 on the mounting bar 20. When the collar 14 is on the shank 24, the strike plate 52 is substantially normal to the major axis 22 of the mounting tube 20, and substantially parallel to the flange 32.

In order to use the coupling device 10, a user first places the collar 14 over the shank 24 of the mounting bar 20 so that the strike plate 52 of the collar 14 abuts the flange 32 on the mounting bar 20. The shank 24 is then inserted into a trailer hitch receiver tube (not shown), and one set of holes 26 is aligned with holes in the receiver tube, and a hitch pin (not shown) is inserted therethrough and secured so that it cannot fall out of the aligned holes. The set of holes 26 should be selected that, when aligned with the holes in the trailer hitch receiver tube, provides the least clearance for the collar 14 to slide between the flange 32 and the end of the trailer hitch receiver tube.

The user then inserts one or more bolts 36 into the holes 34 in the flange and tightens the bolts against the strike plate 52 so that the end of the tube 50 on the collar 14 distal to the strike plate 52 abuts the end of the trailer hitch receiver tube (not shown) or other tube (not shown). As the bolts 36 are tightened, they cause a tensile force through the flange 32 on the mounting tube portion 12 of the coupling device 10 against the hitch pin (not shown), and the mounting tube portion 12 of the coupling device 10 is thereby rigidly attached to the trailer hitch receiver tube or other tube. Because the coupling device 10 is substantially rigid, it is possible to mount a variety of accessories on the mounting plate 40, and the accessories will not suffer from the slop or play found in a conventional mating between a trailer hitch receiver tube and a drawbar that is simply pinned through the receiver tube. Such accessories as bicycle racks and cargo platforms become significantly more stable, and many other accessories can be effectively mounted to vehicles in this way, including even motion sensitive equipment such as video equipment.

In an alternative embodiment, holes 34 may be defined by strike plate 52 instead of flange 32, and the bolts 36 may be inserted through the strike plate 52 instead of the flange 32 such that the bolts 36 are tightened against the flange 32. In such an embodiment, the flange 32 would be substantially sold in the areas where the bolts 36 strike against the flange 32.

In another alternative embodiment, nuts or weld nuts may be used to secure or leverage the bolts 36 between the flange 32 and strike plate 52. In such embodiments, holes 34 may be defined in either of the flange 32 or strike plate 52.

The coupling device 10 may be constructed from any substantially rigid materials including metals such as steel and iron.

While the coupling device 10 has been described in reference to some exemplary embodiments, these embodiments are not limiting and are not necessarily exclusive of each other, and it is contemplated that particular features of various embodiments may be omitted or combined for use with features of other embodiments while remaining within the scope of the invention. In particular, the coupling device 10 is not limited to use with vehicle trailer hitch receiver tubes, and it will be readily apparent to those of skill in the art that the coupling device 10 may be readily used with any tubular mount.

I claim:

1. A coupling device, comprising:
a mounting tube having a shank defining at least one hole therethrough, the shank sized to be received within a receiving tube;
a flange attached to the mounting tube;
a collar disposed on the mounting tube between the receiving tube and the flange;
a strike plate attached to the collar and disposed proximate to the flange; and
the flange or the strike plate defining a through-hole.

2. The device of claim 1, further comprising:
a bolt disposed within the through-hole.

3. The device of claim 2, further comprising:
wherein the through-hole is threaded.

4. The device of claim 1, further comprising:
a mounting plate attached to the mounting tube.

5. The device of claim 1, further comprising:
a mounting post attached to the mounting tube.

6. The device of claim 5, further comprising:
a reinforcing member attached to the mounting tube and the mounting post.

7. The device of claim 5, further comprising:
wherein the mounting post is substantially normal to the mounting tube.

8. The device of claim 1, further comprising:
the mounting tube defining a hole in an end portion distal to the shank, and the end portion sized to receive a shank from an additional tube.

9. A coupling device, comprising:
a substantially rigid, elongate tube having a major axis and a shank defining a proximate end of the elongate tube wherein the shank is sized to be received within a receiving tube;
the shank further defining at least one hole therethrough;
a substantially planar flange attached to the elongate tube wherein the flange is substantially normal to the major axis of the elongate tube;
a collar slidably disposed on the elongate tube between the receiving tube and the flange;
a substantially planar strike plate attached to the collar wherein the strike plate is substantially normal to the major axis of the elongate tube and disposed proximate to the flange; and
the flange or the strike plate defining at least one through-hole.

10. The device of claim 9, further comprising:
a bolt disposed within the at least one through-hole.

11. The device of claim 10, further comprising:
wherein the through-hole is threaded.

12. The device of claim 9, further comprising:
a mounting plate attached to the elongate tube.

13. The device of claim 9, further comprising:
a mounting post attached to the elongate tube.

14. The device of claim 13, further comprising:
a reinforcing member attached to the elongate tube and the mounting post.

15. The device of claim 13, further comprising:
wherein the mounting post is substantially normal to the elongate tube.

16. The device of claim 9, further comprising:
the elongate tube defining a hole in an end portion distal to the shank, and the end portion sized to receive a shank from an additional tube.

17. A coupling device for securely attaching objects to a trailer hitch receiver, comprising:
a substantially rigid, elongate tube having a major axis and a shank defining a proximate end of the elongate tube wherein the shank is sized to be received within the receiver;
the shank further defining at least one hole therethrough;
a substantially planar flange attached to the elongate tube wherein the flange is substantially normal to the major axis of the elongate tube;
a collar slidably disposed on the elongate tube between the receiver and the flange;
a substantially planar strike plate attached to the collar wherein the strike plate is substantially normal to the major axis of the elongate tube and disposed proximate to the flange;
the flange or the strike plate defining at least one threaded through-hole;
a bolt disposed within the at least one threaded through-hole;
a mounting post attached to the elongate tube substantially normal to the major axis of the tube; and
a mounting plate attached to the mounting post.

18. The device of claim 17, further comprising:
a reinforcing member attached to the elongate tube and the mounting post.
